(19) United States
(12) Patent Application Publication
(10) Pub. No.: US 2007/0222665 A1
(43) Pub. Date: Sep. 27, 2007

(54) Airborne Situational Awareness System

(76) Inventor: Robert L. Koeneman, Fort Walton Beach, FL (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/683,213

(22) Filed: Mar. 7, 2007

Related U.S. Application Data
(60) Provisional application No. 60/779,820, filed on Mar. 7, 2006.

(51) Int. Cl. G01S 13/93; G08G 5/04

(52) U.S. Cl. 342/29; 340/961; 342/195; 342/181; 342/357.07

(57) ABSTRACT

A digital airborne situational awareness system and method. The system is installed on multiple aircraft to generate an airborne network providing collision avoidance without ground control. A global positioning system (GPS) receiver unit is coupled to a microprocessor in each aircraft equipped with the system. A software engine receives the raw GPS data and determines location, speed, flight path direction, and altitude. The software engine conditions the GPS data for display on a cockpit display panel. The conditioned data orients the display with the heading, speed, and altitude data of the host system aircraft. A transceiver section provides data transmission to other airborne receiving units within the approximately forty mile range of the airborne network. The transceiver transmits data packets including reconditioned location (track), altitude, and an aircraft class identifier to other aircraft in the network. The transceiver receives data from other airborne vehicles equipped with the system within the network range. Once the computations of positional data for other aircraft are performed, the positional data is sent to the display processing section for appropriate cockpit display. The software engine develops a set of projections that are compared to the relative speed, flight path direction and altitude of the all other units in the airborne network. These projections determine the threat levels of converging flight paths with limits that provide warning data to the pilot of any pending flight path conflict situation.

### CROSS-REFERENCE TO RELATED APPLICATION

This patent application claims the benefit of a provisional patent application entitled “Airborne Situational Awareness System,” filed on Mar. 7, 2006 as U.S. patent application Ser. No. 60/779,820 by the inventor named in this patent application. The specification and drawings of the provisional patent application are specifically incorporated herein by reference.

### BACKGROUND OF THE INVENTION

The present invention relates generally to radio frequency transmission systems and, more particularly, to aircraft location, identification and collision avoidance systems for manned, remotely-piloted and autonomous unmanned aircraft.

There are numerous prior art aircraft location, identification and collision avoidance systems and generally the systems are under control of ground control facilities such as enroute air traffic controllers and airport flight operations control. Such systems rely on radar and two-way voice radio communications to avoid potential collisions. Radar has well-known limitations including limited range accuracy and insufficient target resolution at a critical, near-collision state when two aircraft are close together. To remedy certain deficiencies of ground-based air traffic control, the Federal Aviation Administration (FAA) has approved an aircraft collision avoidance system known as the Traffic Alert and Collision Avoidance System (TCAS).

The TCAS is an airborne traffic alert and collision avoidance advisory system that operates without support from air traffic control ground stations. TCAS detects the presence of nearby target aircraft equipped with transponders that reply to radar interrogating signals. TCAS tracks and continuously evaluates the threat potential of these aircraft in relation to the host aircraft; displays the nearby transponder-equipped aircraft on a traffic advisory display; and provides traffic advisory alerts and vertical maneuvering resolution advisories to assist the pilot in avoiding mid-air collisions. A TCAS includes a transmitter, a transmit antenna, a transponder, directional receiver antennas, a control interface, display, and a signal/control processor. A TCAS determines the location of other aircraft by using the cooperative radar transponders located in other aircraft. A TCAS transmitter asynchronously polls other aircraft with an active L-band interrogating signal. When a target aircraft's cooperative transponder receives a TCAS interrogating signal, the transponder transmits a reply signal. The TCAS control logic uses the range, relative bearing, and pressure altitude determined by the interrogating signal and radar transponder replies to track target aircraft.

The TCAS system has a number of disadvantages. This system issues numerous false alarms and/or erroneous commands or instructions, which may actually increase the probability of collision. The TCAS system also assumes a non-accelerating aircraft track. TCAS requires an elaborate direction finding antenna array and processing logic to find a target aircraft's relative direction. Furthermore, the existing TCAS system cannot detect a collision danger with an aircraft that does not have a functional pressure altimeter. There is a need for a system that provides improved collision avoidance without ground control.

An embodiment of the present invention employs the satellite-based global positioning system. The global positioning system (GPS) is funded and controlled by the U.S. Department of Defense (DOD). In order for the GPS system to be effective for air navigation, a set of four satellites is required to calculate a single fix of coordinates. The GPS system calculates the position, velocity, time and altitude of an aircraft. The system used by civilians is known as the Standard Positioning Service (SPS). The system is free for use and is not restricted. The accuracy of the SPS is intentionally downgraded by the DOD, but is still 95% accurate. The military version of GPS is known as the Precise Position System (PPS) and requires that authorized users have cryptographic equipment, keys, and specially equipped receivers.

### SUMMARY OF THE INVENTION

Embodiments of the present invention are directed to a digital airborne situational awareness system and method. The digital airborne situational awareness system includes integrated electronic hardware modules and software. The installation of the system on multiple aircraft makes an airborne digital network possible, thereby providing collision avoidance without ground control. A global positioning system (GPS) receiver unit is coupled to a microprocessor in each aircraft equipped with the system. The software receives the raw GPS data and determines location, speed, flight path direction, and altitude. The software conditions the raw GPS data for proper display on a cockpit display panel. The conditioned data orients the display with the heading, speed, and altitude data of the host system aircraft. A transceiver section provides data transmission to other airborne receiving units within the approximately forty mile range of the airborne digital network.

At precise timing sequences, the transceiver transmits data packets to other aircraft in the network. The data packets include reconditioned GPS location (track), altitude, and an aircraft class identifier. The transceiver also receives data from other airborne vehicles equipped with the airborne situational awareness system within the 40-mile digital network range. Once the computations of positional data for other aircraft are performed by the software, the positional data is sent to the display processing section for appropriate display of other airborne vehicles on the cockpit display.

In an exemplary embodiment, the software develops a set of projections that is compared to the relative speed, flight path direction and altitude of all the participating units in the airborne network. These projections will determine the threat levels of converging flight paths with limits that provide warning data to the pilot of any pending flight path conflict situation. The situational awareness system includes the capability of unmanned aerial vehicles being programmed to react to this data for autonomous flight path deviation, enabling such vehicles to deviate from pending flight path conflicts.

In one aspect of the invention, a method is provided for generating an airborne network for collision avoidance without ground control, wherein the airborne network includes a plurality of aircraft. A data link is established for each aircraft to a plurality of navigational satellites for providing global positioning system (GPS) data including location, heading, and speed at each time fix for each aircraft. The GPS data is received and the location data is converted into a Cartesian coordinate system data for each aircraft. The converted location, heading, speed, and time fix data are transmitted from a host aircraft to a plurality of target aircraft within a coverage range of the network. The converted location, heading, speed, and time fix data is received from the plurality of target aircraft. A relative position of each target aircraft to a host aircraft is displayed. A determination is made if any target aircraft is on a collision course with the host aircraft. A warning alert is provided to the host aircraft, if any target aircraft is on a collision course with the host aircraft. A course deviation is automatically provided for the host aircraft to avoid collision.

In another aspect of the invention, a system is provided for generating an airborne network for collision avoidance without ground control, wherein the airborne network includes a plurality of aircraft. A GPS receiver establishes a data link for each aircraft to a plurality of navigational satellites and receives global positioning system (GPS) data including location, heading, and speed at each time fix for each aircraft. A microprocessor is coupled to the GPS receiver for executing a software engine comprising a plurality of modules including a module for converting the location data into a Cartesian coordinate system data for each aircraft. A transceiver is coupled to the microprocessor for transmitting the converted location, heading, speed and time fix data from a host aircraft to a plurality of target aircraft within a coverage range of the network and for receiving the converted location, heading, speed, and time fix data from the plurality of target aircraft.

The software engine includes a component for displaying a relative position of each target to the host aircraft; a module for determining if any target aircraft is on a collision course with the host aircraft; a module for providing a warning alert to the host aircraft if any target aircraft is on a collision course with the host aircraft; and a module for automatically providing a course deviation for the host aircraft to avoid collision.

In yet another aspect of the invention, a computer program product is provided for generating an airborne network for collision avoidance without ground control, wherein the airborne network includes a plurality of aircraft. The computer program product comprises a computer readable medium having computer readable code embedded therein. The computer readable medium comprises program instructions for establishing a data link for each aircraft to a plurality of navigational satellites for providing global positioning system (GPS) data including location, heading and speed at each time fix for each aircraft; program instructions for receiving GPS data and converting the location data into a Cartesian coordinate system data for each aircraft; program instructions for transmitting the converted location, heading, speed and time fix data from a host aircraft to a plurality of target aircraft within a coverage range of the network; program instructions for receiving the converted location, heading, speed and time fix data from the plurality of target aircraft; program instructions for displaying a relative position of each target aircraft to the host aircraft; program instructions for determining if any target aircraft is on a collision course with the host aircraft; program instructions for providing a warning alert to the host aircraft if any target aircraft is on a collision course with the host aircraft; and program instructions for automatically providing a course deviation for the host aircraft to avoid collision.

### BRIEF DESCRIPTION OF THE DRAWINGS

These and other advantages and aspects of the present invention will become apparent and more readily appreciated from the following detailed description of the invention taken in conjunction with the accompanying drawings, as follows.

FIG. 1 illustrates the hardware and software components in accordance with an exemplary embodiment of the invention.

FIG. 2 illustrates an exemplary environment in which the airborne situational awareness system can be deployed.

FIG. 3 illustrates the processing logic employed by the software engine in accordance with an exemplary embodiment of the invention.

FIG. 4 illustrates more detailed processing logic for the ASAS software in accordance with an exemplary embodiment of the invention.

FIG. 5 illustrates exemplary processing logic executed by the ASAS software when automatic steering is selected.

FIG. 6 illustrates an exemplary ASAS display of the host aircraft, centered on the display, and potential collision or proximity targets.

FIGS. 7A-7B illustrate a pictorial representation of the variables that are calculated in order to plot the relative positions of target aircraft on the ASAS display.

FIG. 8 illustrates a multi-dimensional ASAS display provided to the aircrew in accordance with an exemplary embodiment of the invention.

FIG. 9 illustrates an exemplary use of color coding to represent different types of targets and relative collision risk.

### DETAILED DESCRIPTION OF THE INVENTION

The following description of the invention is provided as an enabling teaching of the invention and its best, currently known embodiment. Those skilled in the relevant art will recognize that many changes can be made to the embodiments described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and may even be desirable in certain circumstances, and are a part of the present invention. Thus, the following description is provided as illustrative of the principles of the present invention and not in limitation thereof, since the scope of the present invention is defined by the claims.

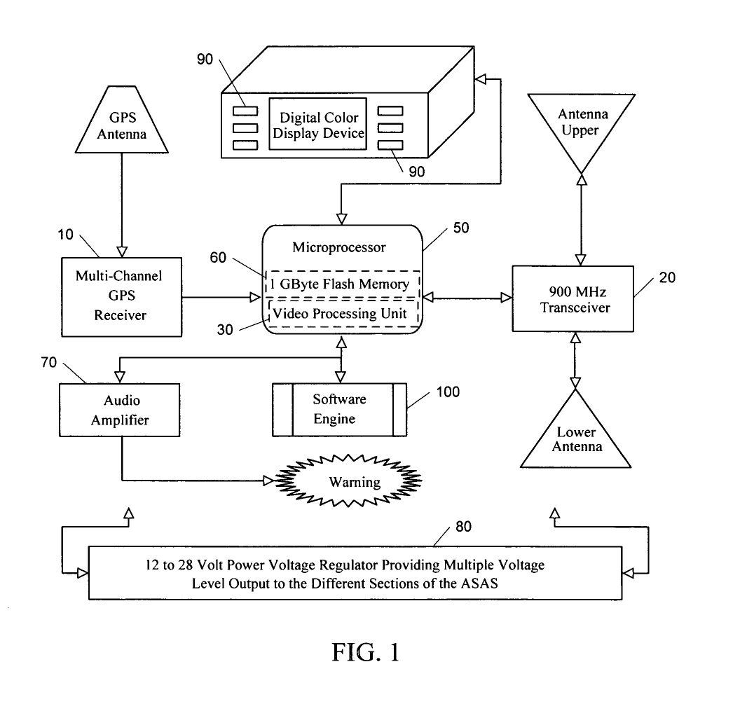

The Airborne Situational Awareness System (ASAS) is a digital electronic device that can be carried by all vehicles that are capable of flight. FIG. 1 illustrates the hardware and software components (i.e., software engine 100) in an exemplary embodiment of the invention. Each ASAS unit includes several electronic hardware modular sections that are integrated to form the ASAS system. These hardware components are as follows:

1) Global Positioning System Receiver (GPS) 10

2) 40-Mile 900 MHz Transceiver 20

3) Video Processing Unit 30

4) Color Liquid Crystal Display (LCD) 40

5) Microprocessor 50

6) Flash Memory 60

7) Audio Amplifier 70

8) Power Supply 80

9) Interrupt Switches 90

The GPS and transceiver sections are described in greater detail below. The graphical aircraft situational displays presented on the LCD device are also described below.

In addition to the electronic hardware components, there is a software engine that drives the operation of the ASAS. The software uses the inputs from the GPS component that provides location, speed, flight path direction and altitude data. The software then conditions this raw GPS data for proper display on the cockpit display panel. This data will orient the display with heading, speed and altitude data of the host system aircraft. The transceiver section is provided the data for transmission to other receiving units within the 40 statute mile range of the airborne network.

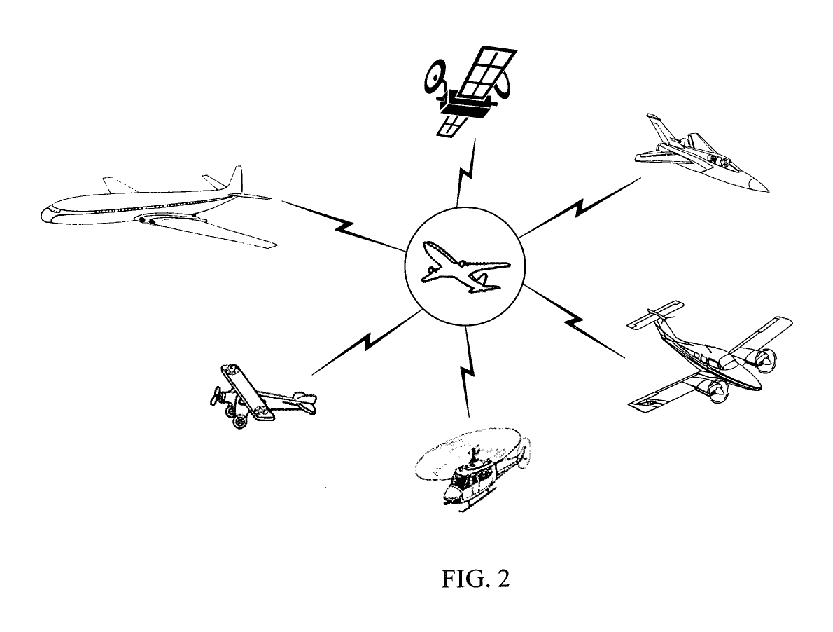

FIG. 2 illustrates an exemplary environment in which the airborne situational awareness system can be deployed. At precise timing sequences the transceiver is receiving data from other airborne vehicles equipped with an ASAS unit and located within the 40-mile network range. The data contains elements of the GPS location, speed, flight path direction and altitude data for each of the other airborne vehicles.

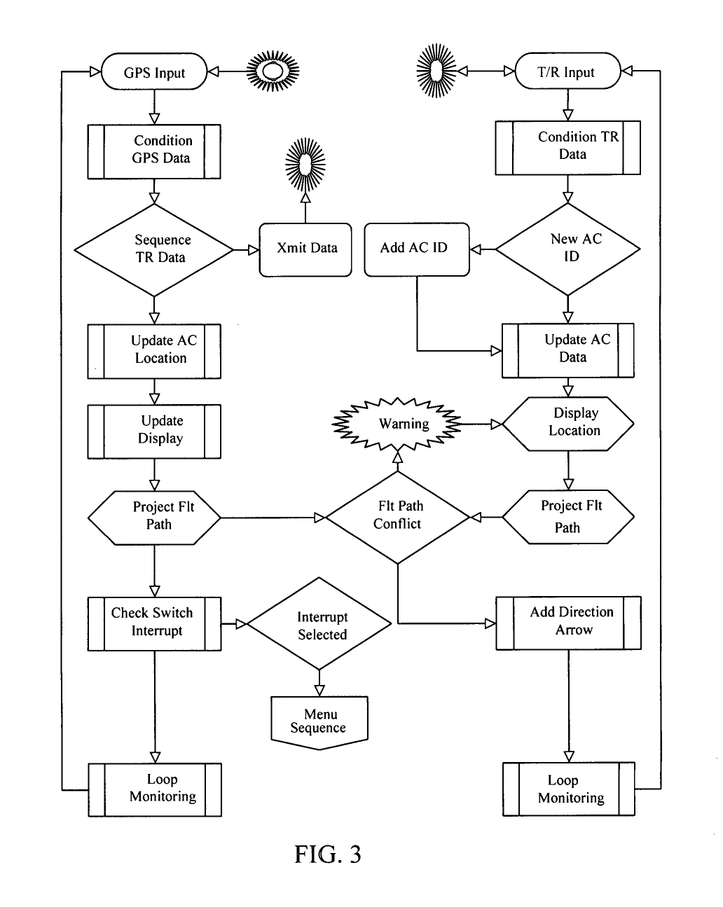

The software engine, running in the microprocessor section of the ASAS unit, provides manipulation of this data. FIG. 3 illustrates the processing logic employed by the software engine in an exemplary embodiment of the invention. The software to provide location data relative to the location of each unit applies unique mathematical computations. Once the computations have been developed, the data is sent to the display processing section for proper display of other vehicles on the cockpit display.

The software also develops a set of projections that are compared to the relative speed, flight path direction and altitude of all the participating units. These projections will determine threat levels of converging flight paths with limits that provide warning data to the pilot of pending flight path conflict situations. This also includes the capability of Unmanned Aerial Vehicles (UAV) to be programmed to react to steering commands generated by the ASAS unit achieving autonomous flight path deviation and allowing UAVs to deviate from pending flight path conflicts. After resolution of the conflict, UAVs can be returned to their intended flight paths.

A 40-mile 900 MHz transceiver that could be included in an embodiment of the invention is the 9XTend™ OEM RF module available from MaxStream, Inc. The design and operation of this transceiver is fully described in two published patent applications: US 2002/0039380 for “Frequency Hopping Data Radio” and US 2002/0041622 for “Spread Spectrum Frequency Hopping Communications System.” Another 900 MHz transceiver that could be included is the AC4790 transceiver module available from AeroComm, Inc. Operation of the AC4790 900 Hz transceiver is described in the AC4790 User's Manual including the ability of the transceiver to use “on-the-fly” control command, referred to as “CC command mode.” The CC command set allows many parameters to be changed during system operation. Other transceivers having comparable capabilities are also suitable for use in embodiments of the invention.

The ASAS transceiver can operate in the ISM 902-928 MHz band using frequency hopping spread spectrum (FHSS) and frequency shift keying (FSK) modulation. The ASAS transceiver can include three channel sets, with RF channel number settings (hexadecimal) and frequency details as shown in Table 1.

TABLE 1

| | RF Channel | | |
|---|---|---|---|
| | Number | Frequency Details and | |
| Channel Set | Range(0x40) | Regulatory Requirements | Countries |
| 0 | 0x00-0x0F | 902-928 MHz (26 hop bins) | US/Canada |
| 1 | 0x10-0x2F | 902-928 MHz (50 hop bins) | US/Canada |
| 2 | 0x30-0x37 | 915-928 MHz (22 Hop Bins) | US/Canada/ |
| | | | Australia |

In one embodiment, the transceiver could use the 64-bit Data Encryption Standard (DES) encryption algorithm for data security. The DES algorithm is a common, simple and well-established encryption routine. An encryption key of 56 bits is used to encrypt the packet. The receiver must use the exact same key to decrypt the packet; otherwise garbled data will be produced. Other encryption algorithms can be used such as the 256-bit Advanced Encryption Standard (AES) encryption algorithm.

The exemplary ASAS transceiver could have three different operating modes: transmit mode, receive mode and command mode. When not in transmit or command mode, the transceiver would be in receive mode ready to receive data and awaiting a synchronization pulse from another transceiver. A transceiver would enter either transmit or command mode when its host aircraft sends data over the serial interface. The state of the transceiver's command/data pin or the data contents would determine which of the two modes will be entered.

During the initialization process, an RF packet is broadcast out to all eligible receivers on the network. Broadcast attempts are used to increase the odds of successful delivery to the intended receivers. Transparent to the host, the sending transceiver will send the RF packet to the intended receiver. If the receiver detects a packet error, it will discard the packet. This will continue until the packet is successfully received or the transmitter exhausts all of its attempts. Once the receiver successfully receives the packet, it will send the packet to the host. It will throw out any duplicates caused by further broadcast attempts. The received packet will only be sent to the host aircraft if it is received free of errors. If an application program interface (API) or hardware acknowledgement is enabled, a broadcast packet will always report success.

The ASAS system could incorporate an ultra-low power GPS receiver board such as the ANTARIS 4 Progammable GPS Module available from u-blox AG. Other GPS engines are also suitable for use in embodiments of the invention. The GPS engine selected should have a small form factor, high tracking sensitivity, and very low power consumption. The assisted GPS (AGPS) functionality provides instant positioning upon request (i.e., fast time to first fix) even in difficult signal conditions. The 16 channel ANTARIS 4 GPS Engine provides high navigation performance even in weak signal environments with a 4 Hz position update rate. The combination of high performance and flexibility of the GPS engine should provide straightforward plug-in system integration.

The GPS link status is monitored during the boot cycle of the ASAS system to ensure that the minimum allowable number of satellites are available for the ASAS functions. A GPS receiver that receives signals from a minimum of three satellites can provide an aircraft with accurate latitude and longitude information. If the GPS receiver receives signals from four satellites, then altitude information can also be provided without reliance on the aircraft's altimeter. If the number of satellites available provides limited functionality, the ASAS system will display messages that inform the user of degraded functionality. Degraded modes could be intermittent and clear as the link status improves. The link status is continuously monitored during system operation by the embedded ASAS software as a function of a System Health Monitoring (SHM) module.

GPS receiver communication data is defined using the National Marine Electronics Association (NMEA) specification. This data includes the complete position, velocity, time (PVT) solution computed by the GPS receiver. The NMEA serial data protocol format is used to send a line of data that is called a sentence. NMEA sentences begin with a ‘S’ character. The data items contained within the sentence are separated by commas. The first word of the sentence is called a data type and defines the interpretation of the rest of the sentence. All of the standard sentences have a two letter prefix that defines the device that uses the sentence type. The prefix if GP for GPS receivers. The prefix is flowed by three characters that define the sentence contents. For example, the GGA sentence provides essential fix data; the RMC sentence provides recommended minimum data for GPS.

The Global Positioning System (GPS) is based on the World Geodetic System of 1984 (WGS84) datum. Geodetic coordinates are the latitude, longitude and height of a point. WGS84 is a geocentric system that uses an ellipsoid whose center is the earth's center. WGS84 defines geoid heights for the entire earth. The reference ellipsoid in the WGS84 datum is described by a series of parameters that define its shape including a semi-major axis, a semi-minor axis, and first and second eccentricities.

The Earth-Centered Earth-Fixed (ECEF) coordinate system is a three-dimensional Cartesian coordinate system that is used to define three-dimensional positions. Its origin is at the earth's center of mass, its X and Y axes coincide with the plane of zero latitude (equator), and the Z axis coincides with the earth's rotational axis. The X axis passes through the point of 0° longitude (i.e., the prime meridian) and 0° latitude (i.e., the equator).

GPS positional data including latitude, longitude, height MSL (i.e., altitude above mean sea level) and height MAP (altitude above ground level) are received and used for processing in the ASAS system. Earth terrain map elevation height defaults to WGS84 mapping elevation heights. The latitude and longitude are provided in degrees, minutes and tenths of a minute. Heights are provided in meters. GPS latitude and longitude must be converted to degrees prior to conversion to ECEF coordinates. The GPS NMEA data format definition is shown in Table 2.

TABLE 2
GPS NMEA Data Format Definition
NMEA Example:
$GPGGA, POS_UTC, LAT, LAT_REF, LONG, LONG_REF,
FIX_MODE, SAT_USED, HDOP, ALT, ALT_UNIT, GEO,
G_UNIT, D_AGE, D_REF*CC

| $GPRMC/$GPGGA | Definition |
|---|---|
| POS_UTC | UTC of position in hours, minutes and seconds |
| POS_STAT | Position status (A = position data valid, |
| | V = position data invalid) |
| LAT | Latitude |
| LAT_REF | Latitude direction (N = North, S = South) |
| LON | Longitude |
| LON_REF | Longitude direction (E = East, W = West) |
| SPD | Speed over ground (knots) |
| HDG | Heading/track made good (degrees True) |
| DATE | Date |
| MAG_VAR | Magnetic variation (degrees) |
| MAG_REF*CC | Magnetic variation (E = East, W = West) |
| SAT_USED | Number of satellites used in solution |
| HDOP | Horizontal dilution of precision |
| ALT | Antenna altitude |
| ALT_UNIT | Altitude units (Meters/Feet) |
| GEO | Geoid/Elipsoid separation |
| G_UNIT | Geoid units (M/F) |
| D_AGE | Age of last DGPS Fix |
| D_REF | Reference ID of DGPS station |
| CC | Checksum (optional) |

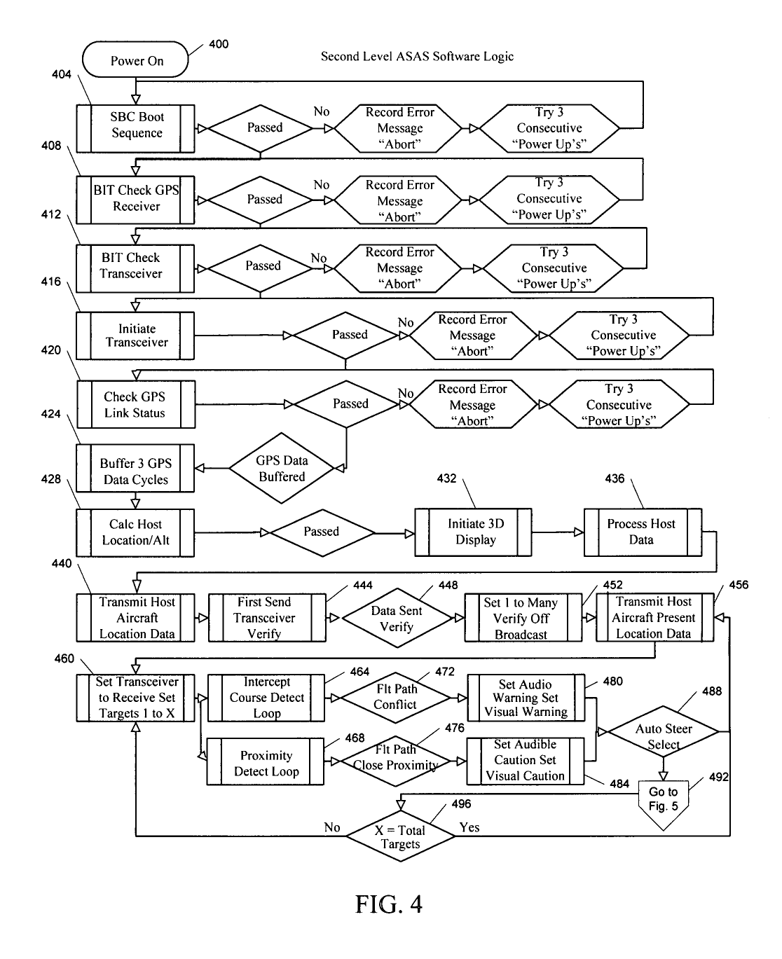

FIG. 4 illustrates more detailed processing logic for an exemplary embodiment of the ASAS software. Processing begins in block 400 when the ASAS system is powered up. The single board computer goes through its boot sequence as indicated in logic block 404. Up to three attempts will be made to pass the boot sequence. If the boot sequence passes, processing continues with a built in test for the GPS receiver, as indicated in logic block 408. Up to three attempts will be made to pass the GPS receiver's built in test. A built in test is then performed on the transceiver as indicated in logic block 412. If the transceiver passes its built in test, processing continues, as indicated in logic block 416 with operational setup of the transceiver. The processing logic associated with setup of the transceiver can be found in the user's manual for the specific transceiver used in an embodiment of the invention.

After the operational setup of the transceiver is completed, processing continue with a check of the status of the GPS link. If the GPS link is operational, then the GPS positional data is buffered for three data cycles as indicated in logic block 424. The location of the host aircraft is then determined, as indicated in logic block 428. As used herein, the host aircraft is the reference aircraft for determination of the locations of other airborne targets within the 40 mile range of the reference aircraft's transceiver. The ASAS LCD display is then initialized as indicated in logic block 432. The host aircraft's positional data is then processed for display. The host aircraft is always centered on the display.

The host aircraft starts to transmit its present location data to other airborne targets within the transceiver's operational range as indicated in logic block 440 (i.e., the transceiver is placed into transmit mode). A transceiver verify signal is transmitted before the host's present location data as indicated in logic block 444. A test is made in decision block 448 to determine if a transceiver verify signal has been sent. In logic block 456, the host aircraft position data is transmitted.

Following transmission of host present location data, the transceiver goes into receive mode to receive present location signals broadcast by other ASAS-equipped aircraft within the operational range of the host aircraft. The software sets the transceiver to receive target location information for each target (also referred to as a target of interest herein), as indicated in logic block 460. Two software routines are then executed as indicated in logic blocks 464 and 468. In logic block 464, an intercept course detection loop is executed to determine if a target aircraft is on a collision course with the host aircraft. In parallel, a proximity detection loop is executed in logic block 468 to determine if a target aircraft will approach in proximity to the host aircraft.

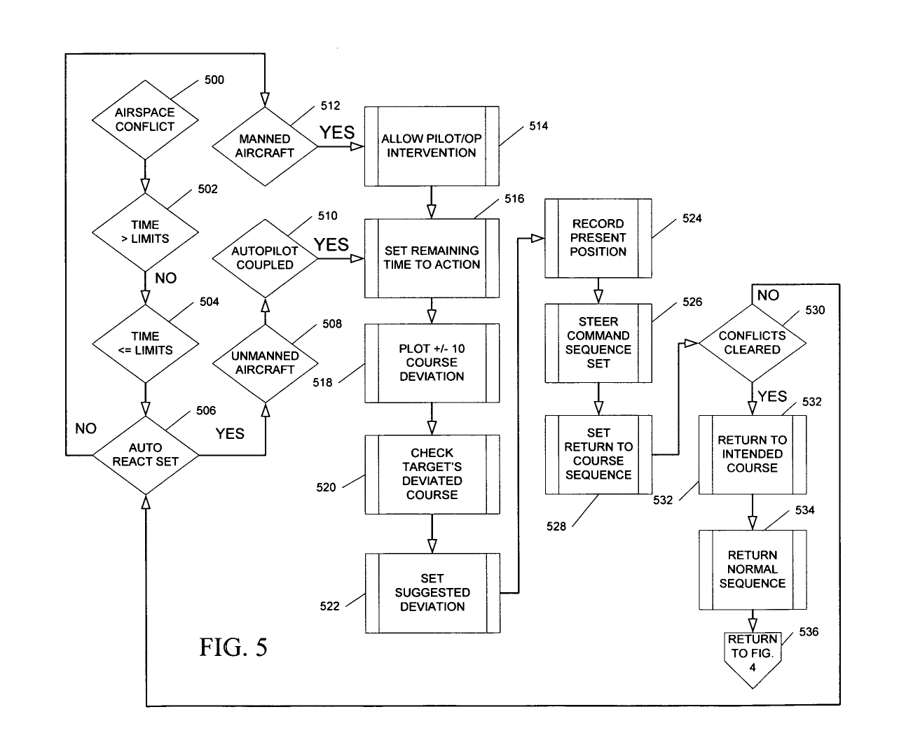

The determination of whether or not a target aircraft is on a collision course or will approach in proximity to the host aircraft can be defined in terms of threshold values set for collision or proximity detection. An example is provided below. Corresponding to the collision and proximity detection loops, tests are made in decision blocks 472 and 476, respectively, to determine if there is a flight path conflict or a close proximity between host and target. For a flight path conflict in decision block 472, both audio and visual warnings will be activated as indicated in logic block 480. For flight paths that will come in close proximity in decision block 476, both audio and visual cautions will be activated as indicated in logic block 480. From logic blocks 480 and 484, a test is then made in decision block 488 to determine if automatic steering has been selected to respond to collision or proximity determinations. The processing logic of FIG. 5 is executed (block 492) if automatic steering has been selected. Finally, a test is made in decision block 496 to determine if all targets have been processed. If not, then the processing steps beginning with those represented by logic block 460 are executed for the next target aircraft. If yes, then processing returns to logic block 456 to start the next cycle of transmissions, beginning with the new host aircraft present location data.

FIG. 5 illustrates the processing logic executed by the ASAS software when automatic steering is selected. Processing logic is entered as indicated in decision block 500 when a determination of airspace conflict occurs. In decision block 502, a check is made to determine whether or not the time to the closest point of approach (CPA) exceeds a preset time limit. If not, then in decision block 504, a determination is made as to whether or not the time to the closest point of approach has been reached, or is less than, the preset time limit. If the time to CPA is within the preset limit, a determination is made in decision block 506 as to whether or not auto react mode has been set. If auto react has not been set, then processing continues in decision block 512 where a test is made to determine if the host aircraft is a manned aircraft. From decision block 512, processing continues in logic block 514 with intervention by the pilot or operator allowed. If auto react has been set in decision block 506, then processing continues in decision block 508 where a test is made to determine if the host aircraft is an unmanned aircraft. A check on whether or not the autopilot is coupled to the ASAS system is made in decision block 510.

From both logic block 514 and block 510, processing continues in logic block 516 with setting (i.e., determination) of the remaining time to commence evasive action by the host aircraft. A course deviation of +/−10 degrees is plotted as indicated in logic block 518. The target's course deviation is then checked as indicated in logic block 520. Next, in logic block 522, a suggested deviation by the host aircraft is set. The present position of the host aircraft is recorded as indicated in logic block 524. Processing continues in logic block 526 with the setting of a steering command sequence. This is followed by setting a return to course sequence as indicate din logic block 528.

In decision block 530, a determination is made whether or not the path conflict has been cleared by the course change. If it has not, processing returns to decision block 506. If the conflict has been cleared, then the host aircraft is returned to its intended course as indicated in logic block 532. The ASAS processing logic then returns to normal processing as indicated in logic block 534.

The software performs the following computations based on the received GPS data:
X_{ECEF}: X=(N(Φ)+h)cos(Φ)cos(λ)
Y_{ECEF}: Y=(N(Φ)+h)cos(Φ)sin(λ)
Z_{ECEF}: Z=(N(Φ)(1−e²)+h)sin(Φ)
where:
   Φ, λ, and h are latitude, longitude, and height above ellipsoid (the height above ground level or H_{AGL}), respectively;
   h=H_{AGL}=H+N (meters)
   H=H_{MSL} (height above mean sea level in meters)
   N=H_{MAP} (map elevation height in meters which defaults to WGS84)
N(Φ)=a/(1−e² sin²(Φ)^{1/2} is the radius of curvature in the prime vertical in meters (m)
where:
   a=semi-major earth axis (ellipsoid equatorial radius in meters)
   b=semi-minor earth axis (ellipsoid polar radius in meters)
   f=(a−b)/a=flattening coefficient
   e²=2f−f²=eccentricity squared

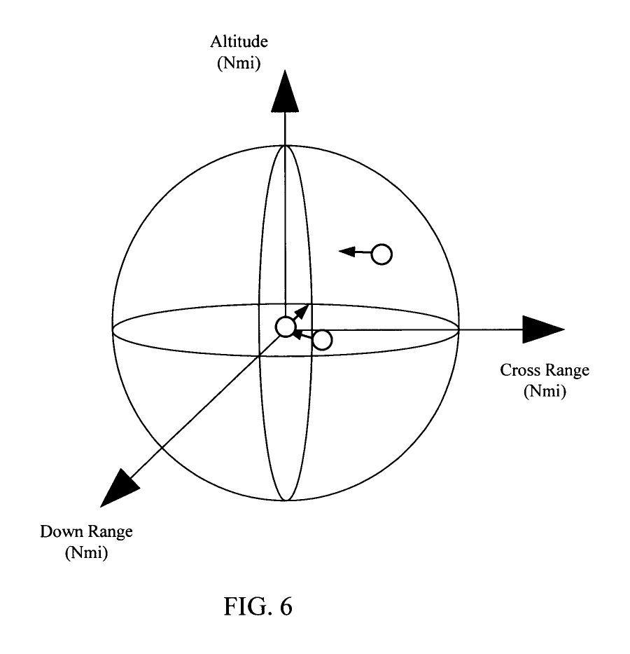

Once the ECEF coordinates of every target (primary target and each collision target) are computed, the delta down range, delta cross range, and delta altitude of each collision target from the primary target (i.e., host aircraft) is computed. These new positions are now in the primary target's inertial reference frame coordinates, and are the values used to plot to the display. The coordinates are displayed in nautical miles. FIG. 6 illustrates an exemplary ASAS display of the host aircraft, centered on the display, and potential collision or proximity targets.

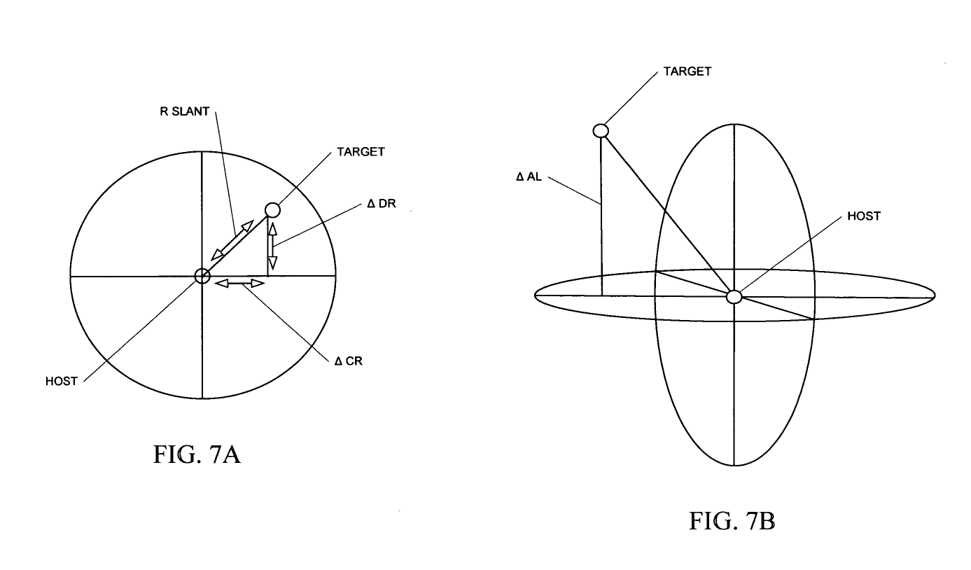

FIGS. 7A-7B illustrate a pictorial representation of the variables that are calculated in order to plot the relative positions of target aircraft on the ASAS display. With reference to these figures, the following calculations determine delta down range (ΔDR), delta cross range (ΔCR), and delta altitude (ΔAL) between the primary target (alternative term for host aircraft) and a potential target of interest:
ΔDR=X_{ECEF}(target of interest)−X_{ECEF}(primary target)
ΔCR=Y_{ECEF}(target of interest)−Y_{ECEF}(primary target)
ΔAL=Z_{ECEF}(target of interest)−Z_{ECEF}(primary target)

The slant range distance (RSLANT) from the host target to the target of interest is then determined by:
R_{SLANT}=(ΔDR²+ΔCR²+ΔAL²)^{1/2}

Fortran-like pseudocode and comments corresponding to these calculations and resulting in determination of slant range from host aircraft to target of interest are as follows:
Step 1: Initialize constants
   DEG2RAD=pi/180.0=0.017453292 (radians/degrees)
   A=3963.34; (units=statute miles)
   B=3949.99; (units=statute miles)
   F=(A−B)/A;
   E2=(2.0*F)−(FA2);
Step 2: Loop over total number of targets read in (1 to MAXTGTS).
   Test for straight line ABT target type (TGTTYPE(TGT)=0). TGTTYPE(TGT)=0 is a read in straight line ABT target with start time (tstart), stop time (tstop), latitude (PHI), longitude (LAMDA), height (h)
   where:
      height (h)=height above mean sea level (H)−WGS84 ellipsoid height (+/−N)),
      h=H−N with units in miles.
      IT=1; (Integer iteration counter for Time=Tstart (To))
         for TGT=1:1: MAXTGTS;
            if (TGTTYPE(TGT)==0);
Step 3: Convert Earth Centered Geodetic Coordinates (ECGC) Radius of Curvature in Prime Vertical (Rcpv) in units of statute miles with respect to the target's latitude (PHI), based on the following formula:
   RCPV(TGT)=N(PHI)=A/(1.0−E2*SINˆ2(PHI))ˆ0.5
   where:
      A=ECGC ellipsoid equatorial radius of the earth (miles)
      E²=eccentricity squared
      E²=2*F−Fˆ2
   where:
      F=flattening coefficient computed from:
      F=(A−B)/A
   where:
      A=ECGC ellipsoid equatorial radius of the earth (statute miles)
      B=ECGC ellipsoid polar radius of the earth (statute miles)
         PHI−Latitude of the target (LAT(TGT)) and is converted
         PHI=LAT(TGT)*DEG2RAD;
         Rcpv(TGT)=A/((1.0−(E2*((sin(PHI))ˆ2)))ˆ0.5);
Step 4: Transform the targets Earth Centered Geodetic Coordinates (ECGC): LAT(TGT), LON(TGT), h(TGT) to Earth Centered Earth Fixed (ECEF) Coordinates:
   Xecef(1:MAXTGT,1:ITmax),
   Yecef(1:MAXTGT,1:ITmax),
   Zecef(1:MAXTGT,1:ITmax)
   where:
      Xecef=(RCPV(TGT)+h(TGT))*COS(PHI)*COS(LAMBDA)
      Yecef=(RCPV(TGT)+h(TGT))*COS(PHI)*SIN(LAMBDA)
      Zecef=(RCPV(TGT)*(1.0−E2)+h(TGT))*SIN(PHI)
   LAMBDA is the longitude of the target (LON(TGT)) and is converted to radians for calculation purposes.
      LAMBDA=LON(TGT)*DEG2RAD;
      Xecef(TGT,IT)=(Rcpv(TGT)+h(TGT))*cos(PHI)*cos(LAMBDA);
      Yecef(TGT,IT)=(RCpv(TGT)+h(TGT))*cos(PHI)*sin(LAMBDA);
      Zecef(TGT,IT)=((Rcpv(TGT)*(1.0−E2))+h(TGT))*sin(PHI);
Step 5: Transform all target ECEF data to the primary target's inertial reference frame coordinate system:
   DELXecef(TGT,IT)=Xecef(TGT,IT)−Xecef(1,IT); (Targets DR component)
   DELYecef(TGT,IT)=Yecef(TGT,IT)−Yecef(1,IT); (Targets CR component)
   DELZecef(TGT,IT)=Zecef(TGT,IT)−Zecef(1,IT); (Targets ΔL component)
Step 6: Convert from statute miles to nautical miles
   DELXecef(TGT,IT)=DELXecef(TGT,IT).*(5280.0/6080.0);
   DELYecef(TGT,IT)=DELYecef(TGT,IT).*(5280.0/6080.0);
   DELZecef(TGT,IT)=DELZecef(TGT,IT).*(5280.0/6080.0);
   Rslant(TGT,IT)=((DELYecef(TGT,IT))ˆ2±(DELXecef(TGT,IT))ˆ2±(DELZecef(TGT,IT))ˆ2)ˆ0.5;

The software engine's flight path projections are continually computed providing updates to the cockpit display unit. If the software engine discovers a threat of flight path conflict, the threat will be displayed on the cockpit display unit providing visual cues of the impending threat. If the threat level is determined to be severe, then an audio cue is also activated to provide an additional flight path conflict threat warning. Once proper actions are taken to eliminate the threat the ASAS system will return to normal operating status.

The actual position of the target of interest is based on the latitude, longitude and altitude of the target of interest. The target of interest location is an offset location from the location of the host or primary target. The latitude, longitude and altitude of the host, target of interest and all other in range targets are continually updated per a cycle, from 0.25 to 8 times per second based on target saturation.

A moving three-dimensional grid marking locations is based on the center location of the host. Points on the grid increments are set to forward and aft longitude and latitude locations. These coordinates with the known GPS altitude of the host and targets give offset locations. These offset locations are then placed on the grid after computation of the slant range (Rslant) equations. A three-dimensional sphere is placed within the grid representing the detection area. The grid is able to be rotated a minimum of 10 degrees of center axis. This means that everything within the grid will rotate in relationship to the correct coordinate system.

Projection of each target's flight path velocity vector is based on velocity and direction of the target of interest. Those targets that can pose a present or future threat of collision will enter into the software routines that will project their future flight paths and compare them to the host target's flight path.

Exemplary pseudocode for the intercept equations is as follows:
Host Altitude=Target Altitude +/−1000 ft
Host Heading+Velocity=Host Future Projected Position in Grid Time Slice
Target Heading+Velocity=Target Future Projected Position in Grid Time Slice
If Host and Target Future Projected Position Cross, then Compare Grid Time Slice
If Host Grid Time Slice and Target Grid Time Slice Pass +/−20 Seconds then
If Time to Intercept <30 seconds then
   Set Collision Visual/Audio Warnings
   If Auto Steer Selected Plot Avoidance Course Maneuver Else if >30
   Set Caution Visual/Audio Warning
Else if Host Grid Time Slice and Target Grid Time Slice Pass >20 Seconds then
   Set Advisory Visual/Audio Cautions
End
If Host and Target Future Projected Position Cross is not a factor then
   Monitor Target Progress

An example of the intercept equation computations follows:
Is Altitude A more than 5000′ (or alternative threshold value) different from the target's Altitude B>|5000|?
GPS Altitude A minus GPS Altitude B.
If YES, then disregard. If NO, proceed to next filter.
Projected heading Host A intersect the target's heading B?
   If NO, disregard. If YES, proceed to next filter.
Is the Intersection of Heading A and Heading B within 40 nm (or alternative threshold) of Position A?
   If NO, disregard. If YES, proceed to next filter.
Compute the Estimated Time of Arrival (ETA) based on GPS airspeed input.
Time to go to INTERSECTION for A

Time to go to the same INTERSECTION for B
If different by plus/minus 30 seconds (or alternative threshold) DISREGARD. If not, ALERT.
Therefore, if a target B relative to host A, meets all the criteria of:
   Altitude within altitude band;
   Headings intersect within 40 nm (or alternative threshold);
   Time to intersection the same plus or minus 30 seconds (or alternative threshold), then Display Unit shows an ALERT.
Host transceiver (A) can receive GPS input of Position, Speed, Heading and Altitude as well as the Re-Transmitted Data providing the same information on the Target (B) for comparison relative to Host (A) position.
   Present Position: A=30.78N 86.52W B=30.47N 87.20W
First computational requirement: Distance from (A) to (B)?
First, compute X:
   X=69.1 (latitude B−latitude A)=69.1(30.47−30.78)=21.421
Now, compute Y:
   Y=53.0 (longitude B−longitude A)=53.0(87.20−86.52)= or 36.04
Final distance determination:
   (X²±Y²)^{1/2}=41.9254 NM

The threat levels and warnings are based on the software engine's mathematical equations that will provide the maximum time to respond to flight path conflicts. The software engine provides capabilities to eliminate false warnings or over-sensitive warnings. Those airborne vehicles that do not pose threats are displayed for information or may be eliminated from the display for clarity. This feature is useful during certain characteristics of flight such as over-flying crowded traffic areas or during the in-route phase of a flight plan. All traffic is still monitored and any threats will still be displayed.

The overall ASAS system is designed to provide in-flight airborne traffic management at the aircrew station or flight control station of any airborne vehicle. The key to the system is that each vehicle will be required to carry a version of the ASAS device that is suitable for that particular vehicle type. Vehicles such as ultra-lights and hot air balloons would not be required to carry anything more than the GPS and transceiver section of the ASAS system that will properly identify them to the flying community around them.

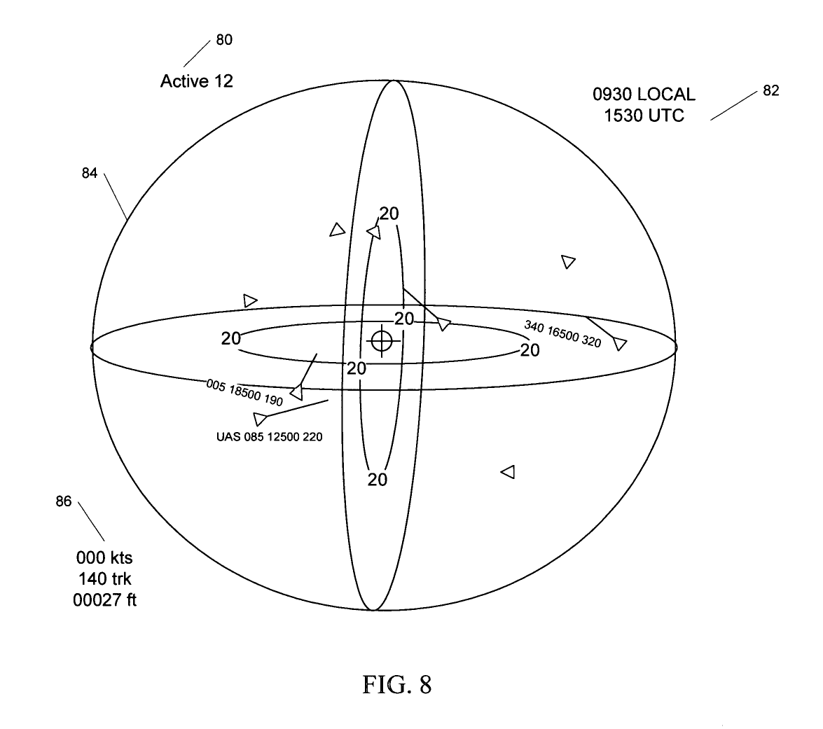

FIG. 8 illustrates a three-dimensional cockpit display of target traffic positions in an exemplary embodiment of the invention. Each airborne vehicle is identified on the display according to type, flight path threat level and maneuvering capability. An example is that of a hot air balloon that has very limited maneuvering capability in comparison to a fixed-wing aircraft that can maneuver very well. In this scenario, the fixed-winged aircraft will have the de-confliction responsibility. The ASAS cockpit display unit will properly identify the hot air balloon on the network so that proper procedures for de-confliction are followed. Aircraft equipped with a steering autopilot could have the option of selecting ASAS de-confliction steering instructions to be sent to the autopilot for an automatic temporary change in flight path course heading to remove any threat of an impending collision. The option of selecting ASAS de-confliction steering instructions applies to both manned and unmanned aerial vehicles.

As illustrated in FIG. 8, an exemplary embodiment of ASAS incorporates a three-axis, three-dimensional display for proper spatial depiction of airborne traffic patterns. These traffic targets and traffic path projections are displayed in correct spatial relationships to the host aircraft's present and predicted positions. The target traffic positions are displayed with altitude, heading and speed. Each traffic target can be selected by touch of the screen to present additional information about a traffic target of interest. This data contains at a minimum, but is not limited to, the aircraft identifier (tail number), type of aircraft and ASAS specific data. ASAS specific data includes intended destination of aircraft, flight path route projection to destination, any data that is deemed useful to share between aircraft in the same airspace, and security data that identifies one ASAS unit to another ASAS unit, as well as establishing the security protocol between ASAS units. The ASAS display provides additional information to the aircrew member including the number of active targets being tracked 80, received GPS data 86, and GPS time 82. GPS time is shown in both local and UTC time. The outer radius of the sphere 84 indicates the coverage range of the ASAS transceiver.

Each target is represented within the sphere as an offset location to the centered host system. These offset locations depict the latitude, longitude, and altitude of the each of the tracked targets from the host system. The addition of target velocity and direction adds the fourth dimension future location based on time.

The sphere is a three-dimensional graphical depiction based on the transceiver's outer range limits of 40 statute miles or 34 nautical miles. The sphere includes combined circles representing the X, Y and Z coordinate system used by the ASAS system. A lubber line is drawn though the center of the sphere representing the centered coordinate reference. The spherical display could be rotated up to 15 degrees in all axes to provide viewing preference selection for the user. In alternative embodiments, a two-dimensional display could be used to represent the host and target aircraft in a manner that is similar to a radar display.

Data derived from the GPS section of ASAS is displayed in set locations on the screen. Aircraft identification data is also displayed at set locations on the screen. The GPS time, both in local time and coordinated universal time (UTC), is also displayed.

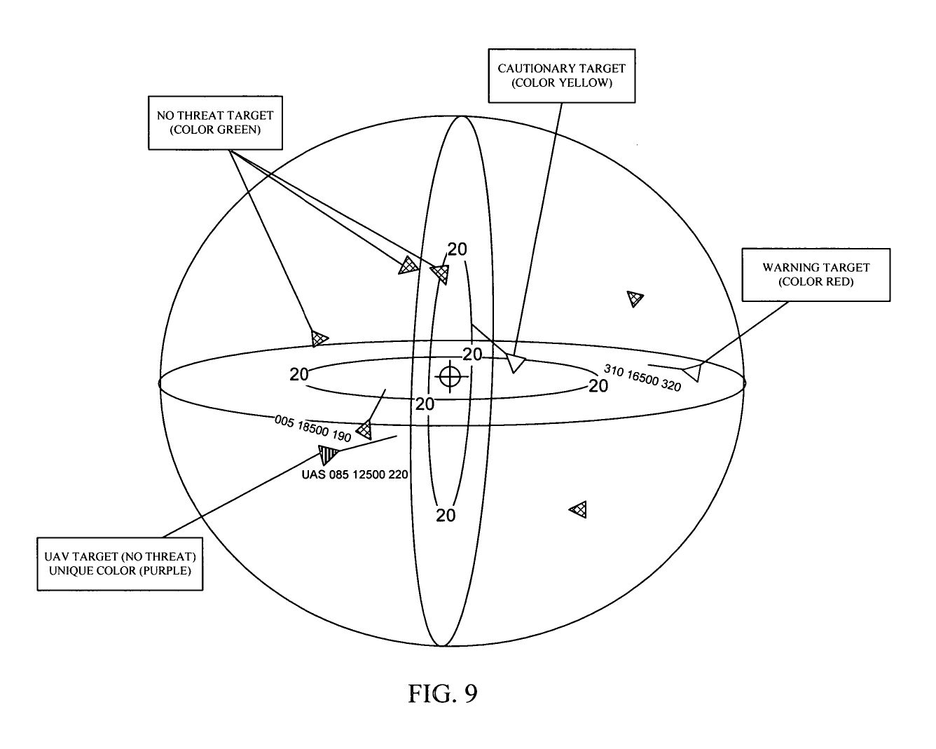

FIG. 9 illustrates an ASAS processor-generated display with an exemplary color-coding scheme. Targets are displayed using a color-coded sequence depicting relational target location priority. Priority targets are those determined by the ASAS software as requiring monitoring and have vector lines attached to them on the display. In an exemplary embodiment, color codes are used to represent different categories of targets. For example, the color red can be employed to represent a target aircraft on an imminent collision course. Similarly, the color yellow can be employed for airborne targets of interest passing within certain levels of proximity. The color green can be used for targets that do not pose a threat level. The color purple can be used to depict Unmanned Aerial Systems (UAS) to draw attention to this airborne target separately. UASs, also referred to herein as UAVs, are tracked the in the same manner as all other airborne vehicles. The vector lines give a graphical representation in line length representing target direction, velocity and altitude. Additional data lines are attached to targets of interest. Data lines include, but are not limited to, type of target, target heading, target altitude and velocity.

ASAS incorporates both visual and audio collision cautions and warnings. Variable settings depicting levels of tolerance will control caution and warning initiation. Tolerances selectable beyond the ASAS system set limits allow for the system to be curtailed for given flight operations.

Caution illumination (display color plus flashing target symbol) with audio warbling tone notification (aircraft speaker, ASAS unit speaker and aircraft intercom interface) will be triggered when host and target aircraft fall within set limits of distance separation from each other. Limits settings are accessible through selectable menu listings for minimum and maximum preferred tolerances. This tolerance may be adjusted to aircrew preferences within system present limitations.

As an example, consider a host aircraft and a target aircraft having a pending/predicted closure path, rate and timing sequence that the two entities will pass below set warning levels. If these settings reflect a warning level of 2000 feet, then any predicted flight path that crosses the host aircraft flight path within 2000 feet, but without collision contact, will set a cautionary warning. An audio tone will be set with visual changes in symbol from non-flashing to flashing amber alert.

A warning illumination (display color plus flashing zoomed target symbol) with audio warbling tone notification (aircraft speaker, ASAS unit speaker and aircraft intercom interface) will be triggered when host and target aircraft are determined as being on a collision course. Limits settings are accessible through selectable menu listings for minimum and maximum preferred time and distance for receiving a pending collision advisory. This tolerance may be adjusted based on aircrew preferences for the type of airspace and air traffic conditions. The tolerances could be set to allow for military aircraft formation or intercept flight such that there is no warning for a given set of known flight parameters.

As an example, consider a host aircraft and a target aircraft having a pending/predicted closure path, rate and timing sequence that the two entities, without intervention, will collide in a set time and distance in the near future. If these settings reflect a five second warning notification, then any predicted flight path determined as being on an intercept course with the host aircraft flight path will set a collision warning. An audio tone will be set with visual changes in symbology from non-flashing to flashing bright red alert.

Additional coded data can be accessed, if desired, by ground units or airborne units that could form an Identification Friend or Foe (IFF) situation to secure airspace through proper aircraft and operator identification. Operator (i.e., pilot/crew member) identification could be established through an Radio Frequency Identification (RFID) tag on an operator's badge that would uniquely identify the operator to the ASAS system. Operator identity could then be transmitted along with other aircraft data to other ASAS units deployed in the airborne network.

The concepts of the airborne situational awareness system are extendible to ground-based air traffic control systems (GCA), aircraft carrier-based control systems (CCA) and airborne warning and control systems (AWACS). For example, a ground-based ASAS system would incorporate similar equipment as provided in ASAS-equipped aircraft for ground terminal operations, but customized for ground control use. The ASAS system could also be installed on ground-based military vehicles, such as tanks and trucks, for monitoring by an AWACS or Joint Surveillance Target Attack Radar System (Joint STARS) aircraft.

The airborne situational awareness system can also provide text messaging capability among ground towers, Air Traffic Control (ATC) centers and aircraft that are equipped with the ASAS system. Ground terminal text messaging capability could provide text-capable clearance delivery, airport or ATC center instructions delivery, and aircraft/aircrew message receive acknowledgement capability.

The airborne situational awareness system has been described as a combination of hardware and software components. It is important to note, however, that those skilled in the art will appreciate that the software of the present invention is capable of being distributed as a program product in a variety of forms, and that the present invention applies regardless of the particular type of signal bearing media utilized to carry out the distribution. Examples of signal bearing media include, without limitation, recordable-type media such as diskettes or CD ROMs, and transmission type media such as analog or digital communications links.

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiment are possible without departing from the scope of the present invention. In addition, it is possible to use some of the features of the present invention without the corresponding use of the other features. Accordingly, the foregoing description of the exemplary embodiment is provided for the purpose of illustrating the principles of the present invention and not in limitation thereof since the scope of the present invention is defined solely by the appended claims.

What is claimed:

1. A method for generating an airborne network for collision avoidance without ground control, wherein the airborne network includes a plurality of aircraft, the method comprising:
establishing a data link for each aircraft to a plurality of navigational satellites for providing global positioning system (GPS) data including location, heading and speed at each time fix for each aircraft;
receiving GPS data and converting the location data into a Cartesian coordinate system data for each aircraft;
transmitting the converted location, heading, speed and time fix data from a host aircraft to a plurality of target aircraft within a coverage range of the network;
receiving the converted location, heading, speed and time fix data from the plurality of target aircraft;
displaying a relative position of each target aircraft to the host aircraft;
determining if any target aircraft is on a collision course with the host aircraft;
providing a warning alert to the host aircraft if any target aircraft is on a collision course with the host aircraft; and
automatically providing a course deviation for the host aircraft to avoid collision.

2. The method for generating an airborne network for collision avoidance of claim 1 wherein the received GPS data conforms to a pre-specified serial data protocol format.

3. The method for generating an airborne network for collision avoidance of claim 2 wherein the received GPS location data includes latitude, longitude, height above mean sea level, and height above ground level.

4. The method for generating an airborne network for collision avoidance of claim 1 wherein the Cartesian coordinate system comprises the Earth-centered Earth-Fixed (ECEF) coordinate system.

5. The method for generating an airborne network for collision avoidance of claim 1 further comprising determining if any target aircraft projected location will approach within a proximity threshold value of the host aircraft location.

6. The method for generating an airborne network for collision avoidance of claim 5 further comprising providing a caution alert to the host aircraft if any target aircraft projected location will approach within a proximity threshold value of the host aircraft location.

7. The method for generating an airborne network for collision avoidance of claim 1 wherein the warning alert comprises a flashing target symbol and an audio warbling tone.

8. The method for generating an airborne network for collision avoidance of claim 6 wherein the caution alert comprises a flashing target symbol and an audio warbling tone.

9. The method for generating an airborne network for collision avoidance of claim 1 wherein displaying a relative position of each target aircraft to the host aircraft comprises:
determining a down range, cross range and altitude differentials between the host aircraft and each target aircraft;
determining a relative position of each target aircraft from the host aircraft based upon the down range, cross range and altitude differentials between the host aircraft and each target aircraft; and
plotting the relative position of each target aircraft on a multi-dimensional display.

10. The method for generating an airborne network for collision avoidance of claim 9 wherein displaying a relative position of each target aircraft to the host aircraft further comprises plotting at least one target aircraft as a vector wherein the vector represents heading and speed of the at least one target aircraft.

11. The method for generating an airborne network for collision avoidance of claim 1 wherein automatically providing a course deviation for the host aircraft to avoid collision with a target aircraft comprises:
determining if an automatic reaction function is set on the host aircraft;
determining if an autopilot on the host aircraft is coupled to an airborne collision avoidance system;
setting a remaining time to initiate a course correction;
determining a course deviation for the host aircraft relative to the current heading; and
generating a steering command sequence to change the host aircraft's heading based on the determined course deviation.

12. The method for generating an airborne network for collision avoidance of claim 11 wherein automatically providing a course deviation for the host aircraft to avoid collision with a target aircraft further comprises:
determining if a collision course conflict with the target aircraft has cleared; and
generating a steering command sequence to change the host aircraft's heading to an intended course.

13. A system for generating an airborne network for collision avoidance without ground control, wherein the airborne network includes a plurality of aircraft, comprising:
a GPS receiver for establishing a data link for each aircraft to a plurality of navigational satellites and receiving global positioning system (GPS) data including location, heading and speed at each time fix for each aircraft;
a microprocessor coupled to the GPS receiver for executing a software engine comprising a plurality of modules including a module for converting the location data into a Cartesian coordinate system data for each aircraft;
a transceiver coupled to the microprocessor for transmitting the converted location, heading, speed and time fix data from a host aircraft to a plurality of target aircraft within a coverage range of the network and for receiving the converted location, heading, speed and time fix data from the plurality of target aircraft;
a component for displaying a relative position of each target aircraft to the host aircraft;
a module for determining if any target aircraft is on a collision course with the host aircraft;
a module for providing a warning alert to the host aircraft if any target aircraft is on a collision course with the host aircraft; and
a module for automatically providing a course deviation for the host aircraft to avoid collision.

14. The system for generating an airborne network for collision avoidance of claim 13 wherein the received GPS data conforms to a pre-specified serial data protocol format.

15. The system for generating an airborne network for collision avoidance of claim 14 wherein the received GPS location data includes latitude, longitude, height above mean sea level, and height above ground level.

16. The system for generating an airborne network for collision avoidance of claim 13 wherein the Cartesian coordinate system comprises the Earth-centered Earth-Fixed (ECEF) coordinate system.

17. The system for generating an airborne network for collision avoidance of claim 13 further comprising a module for determining if any target aircraft projected location will approach within a proximity threshold value of the host aircraft location.

18. The system for generating an airborne network for collision avoidance of claim 17 further comprising a module for providing a caution alert to the host aircraft if any target aircraft projected location will approach within a proximity threshold value of the host aircraft location.

19. The system for generating an airborne network for collision avoidance of claim 13 wherein the warning alert comprises a flashing target symbol and an audio warbling tone.

20. The system for generating an airborne network for collision avoidance of claim 18 wherein the caution alert comprises a flashing target symbol and an audio warbling tone.

21. The system for generating an airborne network for collision avoidance of claim 13 wherein the component for displaying a relative position of each target aircraft to the host aircraft comprises:
a module for determining a down range, cross range and altitude differentials between the host aircraft and each target aircraft;
a module for determining a relative position of each target aircraft from the host aircraft based upon the down range, cross range and altitude differentials between the host aircraft and each target aircraft; and
a module for plotting the relative position of each target aircraft on a multi-dimensional display.

22. The system for generating an airborne network for collision avoidance of claim 21 wherein the component for displaying a relative position of each target aircraft to the host aircraft further comprises a module for plotting at least one target aircraft as a vector wherein the vector represents heading and speed of the at least one target aircraft.

23. The system for generating an airborne network for collision avoidance of claim 13 wherein the module for automatically providing a course deviation for the host aircraft to avoid collision with a target aircraft comprises:
a module for determining if an automatic reaction function is set on the host aircraft;
a module for determining if an autopilot on the host aircraft is coupled to an airborne collision avoidance system;
a module for setting a remaining time to initiate a course correction;
a module for determining a course deviation for the host aircraft relative to the current heading; and
a module for generating a steering command sequence to change the host aircraft's heading based on the determined course deviation.

24. The system for generating an airborne network for collision avoidance of claim 23 wherein the module for automatically providing a course deviation for the host aircraft to avoid collision with a target aircraft further comprises:
a module for determining if a collision course conflict with the target aircraft has cleared; and
a module for generating a steering command sequence to change the host aircraft's heading to an intended course.

25. A computer program product for generating an airborne network for collision avoidance without ground control, wherein the airborne network includes a plurality of aircraft, comprising a computer readable medium having computer readable code embedded therein, the computer readable medium comprising:
program instructions for establishing a data link for each aircraft to a plurality of navigational satellites for providing global positioning system (GPS) data including location, heading and speed at each time fix for each aircraft;
program instructions for receiving GPS data and converting the location data into a Cartesian coordinate system data for each aircraft;
program instructions for transmitting the converted location, heading, speed and time fix data from a host aircraft to a plurality of target aircraft within a coverage range of the network;
program instructions for receiving the converted location, heading, speed and time fix data from the plurality of target aircraft;
program instructions for displaying a relative position of each target aircraft to the host aircraft;
program instructions for determining if any target aircraft is on a collision course with the host aircraft;
program instructions for providing a warning alert to the host aircraft if any target aircraft is on a collision course with the host aircraft; and
program instructions for automatically providing a course deviation for the host aircraft to avoid collision.

26. The computer program product for generating an airborne network for collision avoidance of claim 24 wherein the received GPS data conforms to a pre-specified serial data protocol format.

27. The computer program product for generating an airborne network for collision avoidance of claim 26 wherein the received GPS location data includes latitude, longitude, height above mean sea level, and height above ground level.

28. The computer program product for generating an airborne network for collision avoidance of claim 25 wherein the Cartesian coordinate system comprises the Earth-centered Earth-Fixed (ECEF) coordinate system.

29. The computer program product for generating an airborne network for collision avoidance of claim 25 further comprising program instructions for determining if any target aircraft projected location will approach within a proximity threshold value of the host aircraft location.

30. The computer program product for generating an airborne network for collision avoidance of claim 29 further comprising program instructions for providing a caution alert to the host aircraft if any target aircraft projected location will approach within a proximity threshold value of the host aircraft location.

31. The computer program product for generating an airborne network for collision avoidance of claim 25 wherein the warning alert comprises a flashing target symbol and an audio warbling tone.

32. The computer program product for generating an airborne network for collision avoidance of claim 30 wherein the caution alert comprises a flashing target symbol and an audio warbling tone.

33. The computer program product for generating an airborne network for collision avoidance of claim 25 wherein the program instructions for displaying a relative position of each target aircraft to the host aircraft comprise:
program instructions for determining a down range, cross range and altitude differentials between the host aircraft and each target aircraft;
program instructions for determining a relative position of each target aircraft from the host aircraft based upon the down range, cross range and altitude differentials between the host aircraft and each target aircraft; and
program instructions for plotting the relative position of each target aircraft on a multi-dimensional display.

34. The computer program product for generating an airborne network for collision avoidance of claim 33 wherein the program instructions for displaying a relative position of each target aircraft to the host aircraft further comprises program instructions for plotting at least one target aircraft as a vector wherein the vector represents heading and speed of the at least one target aircraft.

35. The computer program product for generating an airborne network for collision avoidance of claim 25 wherein the program instructions for automatically providing a course deviation for the host aircraft to avoid collision with a target aircraft comprise:
program instructions for determining if an automatic reaction function is set on the host aircraft;
program instructions for determining if an autopilot on the host aircraft is coupled to an airborne collision avoidance system;
program instructions for setting a remaining time to initiate a course correction;
program instructions for determining a course deviation for the host aircraft relative to the current heading; and
program instructions for generating a steering command sequence to change the host aircraft's heading based on the determined course deviation.

36. The computer program product for generating an airborne network for collision avoidance of claim 35 wherein the program instructions for automatically providing a course deviation for the host aircraft to avoid collision with a target aircraft further comprise:
program instructions for determining if a collision course conflict with the target aircraft has cleared; and
program instructions for generating a steering command sequence to change the host aircraft's heading to an intended course.
